(19) United States
(12) Patent Application Publication
(10) Pub. No.: US 2021/0231486 A1
(43) Pub. Date: Jul. 29, 2021

(54) METHOD AND APPARATUS FOR SINGLE DRAFT, STATIC AND DYNAMIC VEHICLE WEIGHING USING THE SAME WEIGHT SCALE

(71) Applicant: Mettler-Toledo, LLC, Columbus, OH (US)

(72) Inventors: Eric V. Wechselberger, Powell, OH (US); Santosh G. Nachu, Worthington, OH (US)

(21) Appl. No.: 16/750,705

(22) Filed: Jan. 23, 2020

(51) Int. Cl. G01G 19/08; G01G 19/02

(52) U.S. Cl. CPC G01G 19/086; G01G 19/022

(57) ABSTRACT

An apparatus and method for determining the total weight of a vehicle either statically or dynamically using the same weight scale. The apparatus is a weight scale for weighing vehicles that is of sufficient length that a plurality of axle sets of a vehicle can be located on the weight scale simultaneously. The apparatus senses the total weight of the vehicle as a function of time within the period of time the vehicle is on the weight scale. The apparatus obtains the vehicle weight statically if all of the axle sets of a vehicle are located on the weight scale simultaneously and the vehicle is in a stopped condition and obtains the vehicle weight dynamically if all of the axle sets of the vehicle are located on the weight scale simultaneously and the vehicle is moving on the weight scale.

### BACKGROUND OF THE INVENTIVE FIELD

The present invention is directed to vehicle scales or weighing instruments used to determine the weight of a vehicle and its contents. The two primary reasons to weigh a vehicle are:

1. To determine the net weight of goods for commercial transactions. By weighing a vehicle both empty and when loaded, the net weight of goods carried by the vehicle can be determined. The net weight is used in commercial transactions when entire truck loads of goods such as agricultural products, waste, aggregates, and chemicals are bought or sold. The accuracy of scales used in commercial transactions is regulated by law to achieve equity between buyers and sellers in the marketplace. In order to achieve the required accuracy, the law requires the entire vehicle to be weighed simultaneously on the scale platform in a “single draft” while stopped on the scale.

2. To check weigh a vehicle for road limit enforcement or inventory control. In this case the weight of a vehicle is compared to an allowed limit or range. The accuracy of scales used in check weighing is not regulated by law and is typically lower than scales used in commercial transactions. Although single draft static scales can be used for this purpose, dynamic weigh-in-motion scales can also be used. Although the weighing accuracy is lower by using dynamic weigh-in-motion scales, productivity is improved by not requiring the vehicle to stop during the weighment.

The objective of this invention is to create a dual mode single draft, static/dynamic vehicle scale that can be used statically at one accuracy level, for example in commercial transactions, and dynamically at the same or a different accuracy level, for example in check weighing.

### SUMMARY OF THE GENERAL INVENTIVE CONCEPT

Traditionally, vehicle scales are produced for use as either a static scale to provide the accuracy required for commercial transactions or as a dynamic scale to obtain high productivity for check weighing. Customers that do both commercial transactions and check weighing typically have two choices in their purchasing decision:

1. Use a single draft static vehicle scale for commercial transactions and a dynamic axle scale for check weighing. This provides the accuracy required for commercial transactions and the productivity required for check weighing, but the cost for two separate scales is high and it may be difficult to find a convenient location for both scales.

2. Use a single draft static scale for both commercial transactions and check weighing. This provides the accuracy required for commercial transactions and higher accuracy than required for check weighing, but the productivity for check weighing is low.

A dual mode single draft, static/dynamic vehicle scale of the present invention provides the accuracy required for commercial transactions and the productivity required for check weighing in a single scale. One embodiment of the present invention is an apparatus for determining the total weight of a vehicle either statically or dynamically using the same weight scale and for displaying the total weight on a terminal display.

In one embodiment of the invention, the apparatus of the present invention is comprised of:

a weight scale for weighing vehicles that is of sufficient length that a plurality of axle sets of a vehicle can be located on the weight scale simultaneously;

a plurality of weight sensors placed along the longitudinal length of the weight scale for sensing the total weight of the vehicle as a function of time within the period of time the vehicle is on the weight scale;

a hardware processing system in electronic communication with the terminal display and plurality of weight sensors. The hardware processing system programmed with instructions when executed configure the processor to:

obtain the vehicle weight statically if all of the axle sets of a vehicle are located on the weight scale simultaneously and the vehicle is in a stopped condition; and

obtain the vehicle weight dynamically if all of the axle sets of the vehicle are located on the weight scale simultaneously and the vehicle is moving on the weight scale.

The hardware processing system may be programmed with further instructions when executed configure the processor to:

determine that all of the axle sets of the vehicle were located on the weight scale simultaneously and the vehicle is moving by analyzing a weight signal waveform as a function of time; and

determine the vehicle weight by using the maximum weight readings of the weight signal waveform.

The weight signal waveform represents a proper waveform for dynamic weighing when the weight signal waveform increases in a stepwise fashion to a maximum level then decreases in a stepwise fashion in a substantially inverse symmetrical fashion.

The hardware processing system may also be programmed with further instructions when executed configure the processor to indicate an error in the dynamic weight obtained if the weight signal waveform is not a proper waveform.

The hardware processing system may be programmed with further instructions when executed configure the processor to determine if the vehicle is moving on the weight scale during the weighing process by detecting the transfer of weight as the vehicle moves across the weight scale.

In one embodiment, the plurality of weight sensors are comprised of:

a first load cell at a first end of the weight scale;

a second load cell at a second end of the weight scale; and

a third and fourth load cells in between the first and second load cells.

The first, second, third and fourth load cells are preferably positioned in a line along the longitudinal axis of the weight scale aligned with the direction of vehicle movement; and the first, second, third and fourth load cells are digital load cells and wherein they are configured to sense weight of loads.

In this embodiment, the hardware processing system is preferably programmed with further instructions when executed configure the processor to determine if the vehicle is moving on the weight scale during the weighing process by detecting the transfer of weight among the first, second, third and fourth load cells as the vehicle moves across the longitudinal length of the weight scale.

The hardware processing system may be programmed with further instructions when executed configure the processor to:

automatically determine the weight of the moving vehicle dynamically if the vehicle is moving on the weight scale during the weighing process;

display the total weight obtained dynamically; and

indicate the total weight as a dynamically obtained weight reading.

The hardware processing system may be programmed with further instructions when executed configure the processor to estimate the speed of the vehicle from the rate of weight transfer among the load cells.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the weight scale of the present invention;

FIG. 2 illustrates an example weight signal waveform that represents a proper waveform for dynamic weighing;

FIG. 3 illustrates another example of a truck with 5 sets of axles as it approaches a weight scale with 4 sets of load cells;

FIG. 4 illustrates a graph of the weight readings of the example of FIG. 3 versus time (pounds vs. seconds);

FIG. 5 illustrates the truck as it initially moves onto the weight scale of FIG. 3 with the truck's first set of axles;

FIG. 6 illustrates the graph of FIG. 4 with one of the truck axles on the scale;

FIG. 7 illustrates the weight scale of FIG. 3 with two sets of the truck axles on the weight scale;

FIG. 8 illustrates the graph of FIG. 4 with two sets of axles on the weight scale;

FIG. 9 illustrates the weight scale of FIG. 3 with all five sets of the truck axles on the weight scale;

FIG. 10 illustrates the graph of FIG. 4 with all five sets of axles on the weight scale;

FIG. 11 illustrates the weight readings of the truck of FIG. 3 as a function of time for the dynamic weighing process from the time the truck approaches the weight scale to the time the truck is moving across the weight scale, and finally to the time the truck is completely off the weight scale;

FIG. 12 illustrates the weight output of the first, second, third and fourth sets of load cells as the truck is moving across the weight scale. The sum of the output of the individual load cell sets creates the total weight waveform; and

FIG. 13 illustrates the method of determining the total weight of a vehicle either statically or dynamically using the same weight scale.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In the preferred embodiment, a single draft vehicle scale is a multiple force-measuring device comprised of:
a weighing platform, sized and adapted to receive the entire vehicle;
a plurality of load cells on which the weighing platform bears; and
a terminal which is connected to the load cells and controls the weighing functions.

In one embodiment of single draft weighing, the weight of a vehicle may be determined by adding together the weights obtained from all of the load cells while all individual vehicle elements (e.g., axles) are resting simultaneously on a scale platform or a scale platform comprised of multiple scale platforms positioned next to each other. A vehicle's weight determined by adding together the results obtained by separately and not simultaneously weighing all individual vehicle elements does not constitute single draft weighing.

Vehicle scales used in commercial transactions are subject to certification and inspection by a Weights & Measures (W&M) authority to assure equity in the marketplace. Because of the need for regularity, national and international organizations have established standards that designate how a vehicle scale is allowed to operate. These standards require a vehicle to be weighed statically in a single draft (i.e., entire vehicle is weighed simultaneously while stopped).

Vehicle scales used in check weighing are not required to be certified and inspected by a Weights & Measures authority. As a result, there is more flexibility in how the vehicle scale may operate. If the accuracy required for vehicle check weighing is high, then the vehicle may still be weighed statically in a single draft. However, many vehicle check weighing applications do not require such a high accuracy but do require vehicles to be weighed quickly. In this case the vehicle may be weighed dynamically in a single draft but without stopping on the scale.

A dual mode single draft vehicle scale according to the present invention can be used in either a static mode or a dynamic mode. In the static mode the entire vehicle stops on the scale. This kind of static single draft weighing provides the highest weighing accuracy typically needed for commercial transactions. In the dynamic mode the entire vehicle drives over the scale without stopping within the speed range capability of the scale. This kind of dynamic single draft weighing provides lower weighing accuracy but at higher productivity levels typically needed for check weighing. The selection of static or dynamic mode depends on the weighing application.

In static mode, a weighment is only displayed, printed, transmitted or stored by the terminal if the vehicle is entirely on the scale and has come to a complete stop for legal compliance. Any weighment made while the vehicle is not entirely on the scale or remains in motion is discarded. One or more sensors are used to determine when the vehicle is entirely on the scale and if the vehicle has stopped or remains in motion. In another embodiment, an operator may manually indicate when a vehicle is entirely on the scale and in a stopped condition. The static mode preferably sets the terminal operation and display based on the W&M requirements for commercial transactions (e.g., weight increment, weight interval, scale capacity, etc.). The terminal indicates that the weighment is legally compliant when displayed, printed, transmitted or stored.

In dynamic mode, a weighment is only displayed, printed, transmitted or stored by the terminal if the vehicle is entirely on the scale and remains in motion while on the scale. Any weighment made while the vehicle is not entirely on the scale or has come to a complete stop is discarded. One or more sensors (e.g., load cells) are used to determine when the vehicle is entirely on the scale and if the vehicle has stopped or remains in motion. An interlock prevents any weighments from being provided if the vehicle's speed is outside the speed operating range of the scale. The dynamic mode sets the terminal operation and display based on the operator's requirements. This may be the same or different than the static mode settings required for commercial transactions (e.g., smaller/larger weight increment, smaller/larger number of weight intervals, smaller/larger scale capacity, etc.). However, since the vehicle did not necessarily come to a complete stop, the terminal indicates that the weighment is not legally compliant when displayed, printed, transmitted or stored. Other information that may also be provided in dynamic weighing mode includes, but is not limited to, single-axle loads, axle-group loads, average vehicle speed, average vehicle acceleration, and direction of travel.

In dynamic mode, there is a maximum and minimum speed limit specification for the vehicle as it drives over the scale. It is only within this speed operating range that the dynamic weighments are accurate. No weighment is provided if the vehicle's speed is above the maximum or below the minimum. In a special case the minimum speed specification may be zero (i.e., vehicle comes to a complete stop). In this case the weighment is still considered to be “dynamic” as long as the scale is in dynamic mode and the terminal operation is set accordingly.

The selection of static or dynamic mode may be done manually by the operator at the terminal. If the mode is manually selected by the operator, then only static or dynamic weighments will be allowed according to the operator's selection. This requires the operator to have some prior knowledge of the weighing application before the vehicle is on the scale. An operator may manually select the dynamic mode, for example, if the scale is used exclusively for check weighing and then only occasionally set the scale in static mode for calibration purposes.

In a preferred implementation, the selection of static or dynamic mode may be done automatically by the terminal. In this way the scale can switch back and forth between static and dynamic modes at will depending on the weighing application. One or more sensors are used to determine the position and speed of the vehicle. If the vehicle is entirely on the scale and has come to a complete stop, then the static mode is automatically enabled. In static mode the terminal operation and display is set based on the W&M requirements for commercial transactions and the weighment is indicated as legally compliant. If the vehicle is entirely on the scale but does not come to a complete stop and remains in motion, then the dynamic mode is automatically enabled. In dynamic mode the terminal operation and display is set based on the operator's requirements, which may be the same or different than static mode, and the weighment is indicated as not legally compliant. Automatic mode selection is better suited when the weighing application could be either commercial transactions or check weighing.

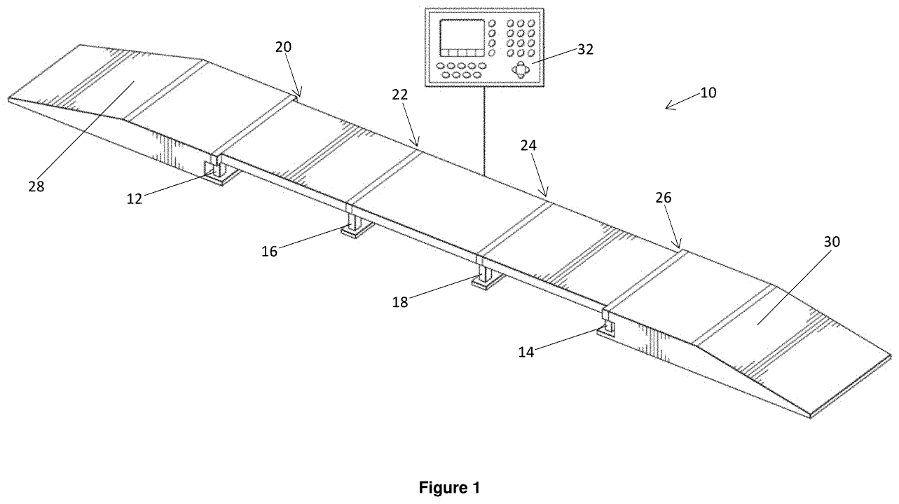

FIG. 1 illustrates one embodiment of the inventive weight scale 10 of the present invention. In the preferred embodiment, the weight scale determines the total weight of a vehicle either statically or dynamically using the sensed weight from the plurality of load cells. The weight scale is preferably of sufficient length that a plurality of axle sets of a vehicle can be located on the weight scale simultaneously. In the preferred embodiment a plurality of weight sensors (e.g., load cells) are placed along the longitudinal length of the weight scale for sensing the total weight of the vehicle as a function of time within the period of time the vehicle is on the weight scale.

In one embodiment, the plurality of weight sensors are comprised of:
a first load cell 12 at a first end of the weight scale;
a second load cell 14 at a second end of the weight scale; and
a third and fourth load cells 16, 18 in between the first and second load cells.

In the preferred embodiment, there are a pair of load cells at predetermined positions along the length of the weight scale that support the scale and obtain weight measurements. For example, load cells would also be placed at locations 20, 22, 24, and 26.

The load cells are preferably placed in a line along the longitudinal axis of the weight scale aligned with the direction of vehicle movement. The load cells are preferably digital load cells and are configured to sense weight of loads. The vehicle enters a first ramp 28, then moves onto the weight scale and off the second ramp 30 located at the second end of the weight scale.

The load cells are in electronic communication with a hardware processing system that obtains the weight readings, processes the data, and electronically sends weight and other information to a terminal display 32. In the preferred embodiment, the hardware processing system is programmed with instructions when executed configure the processor to: obtain the vehicle weight statically if all of the axle sets of a vehicle are located on the weight scale simultaneously and the vehicle is in a stopped condition; and obtain the vehicle weight dynamically if all of the axle sets of the vehicle are located on the weight scale simultaneously and the vehicle is moving on the weight scale.

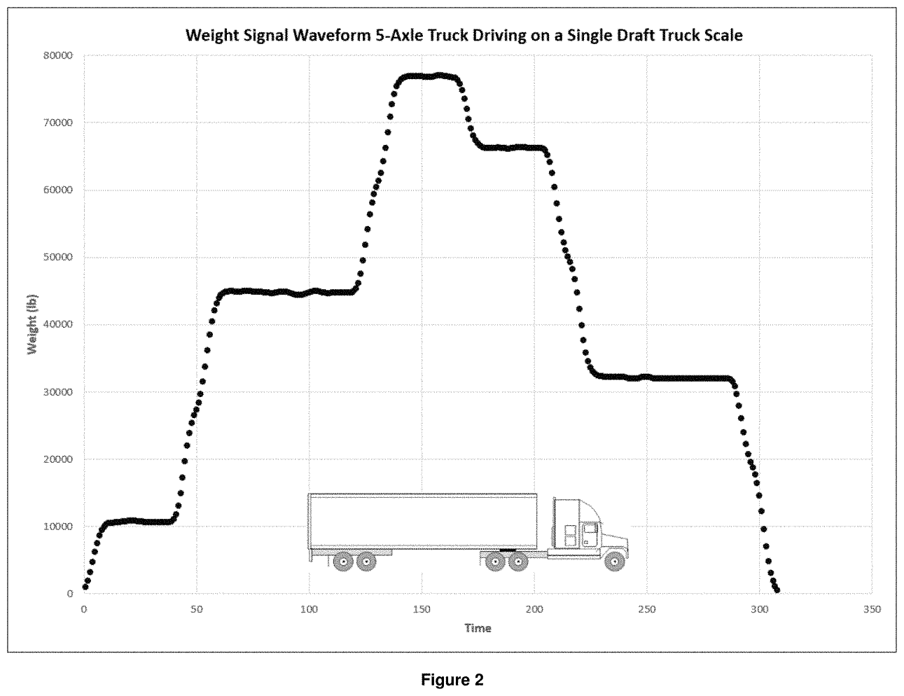

The hardware processing system is programmed with further instructions when executed configure the processor to determine that all the axle sets of the vehicle were located on the weight scale simultaneously and the vehicle is moving by analyzing a weight signal waveform as a function of time. The weight signal waveform represents a proper waveform for dynamic weighing when the weight signal waveform increases in a stepwise fashion to a maximum level then decreases in a stepwise fashion in a substantially inverse symmetrical fashion. FIG. 2 illustrates an example weight signal waveform that represents a proper waveform for dynamic weighing.

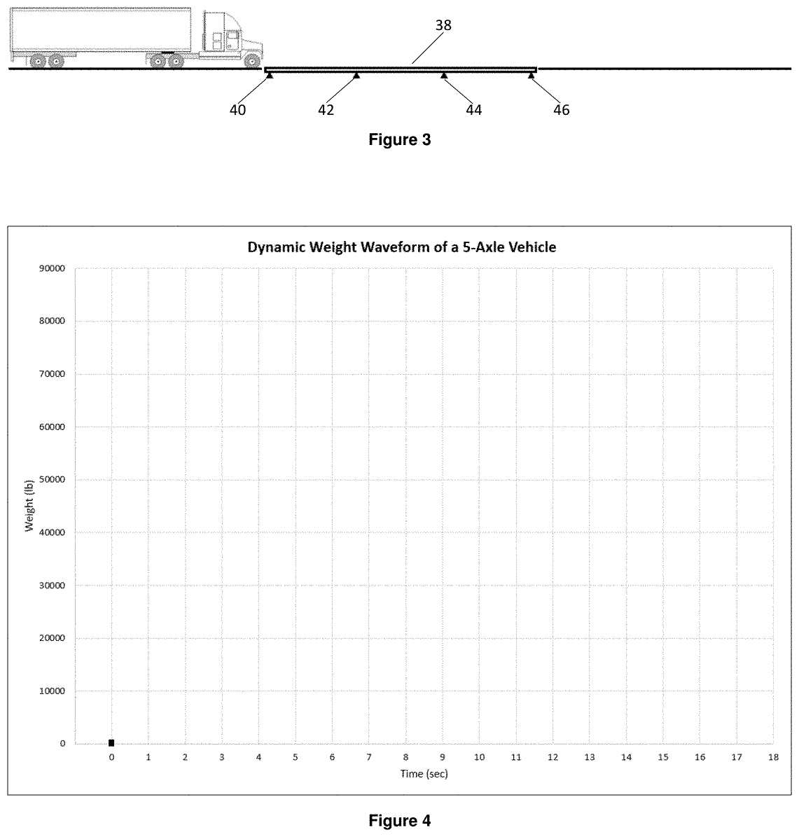

FIG. 3 illustrates another example of a truck with 5 sets of axles as it approaches a weight scale 38 with 4 sets of load cells (shown at 40, 42, 44, 46 respectively). FIG. 4 illustrates a graph of the weight readings of the example of FIG. 3 versus time (pounds vs. seconds). Because the truck in FIG. 3 is not yet on the weighing scale, the weight reading is zero.

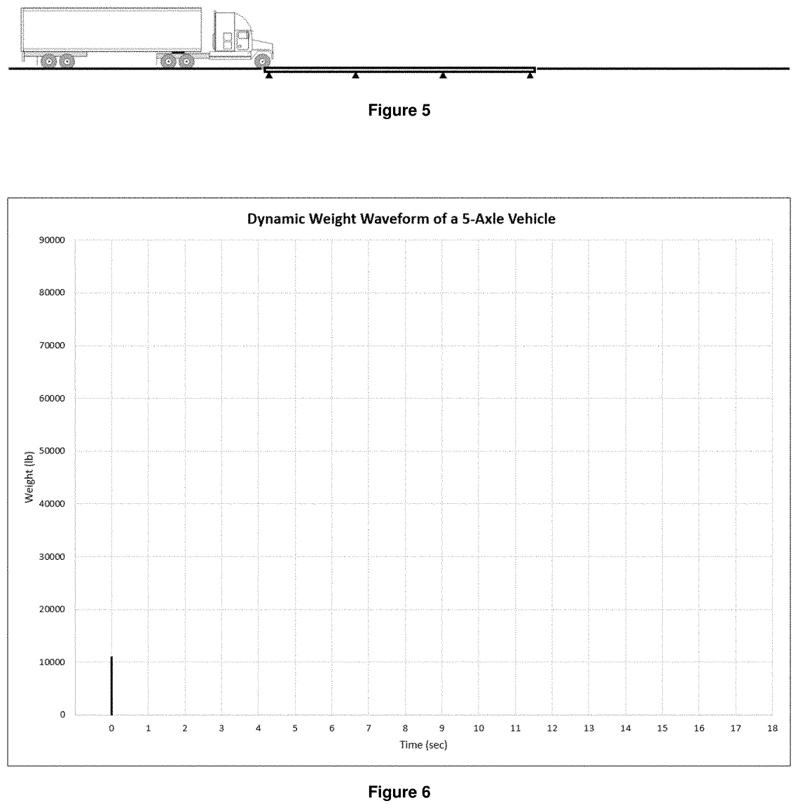

FIG. 5 illustrates the truck as it initially moves onto the weight scale of FIG. 3 with the truck's first set of axles. FIG. 6 illustrates the graph of FIG. 4 with one of the truck axles on the scale. As seen in FIG. 6, as the first axle moves onto the weight scale, the weight reading increases to a new non-zero value.

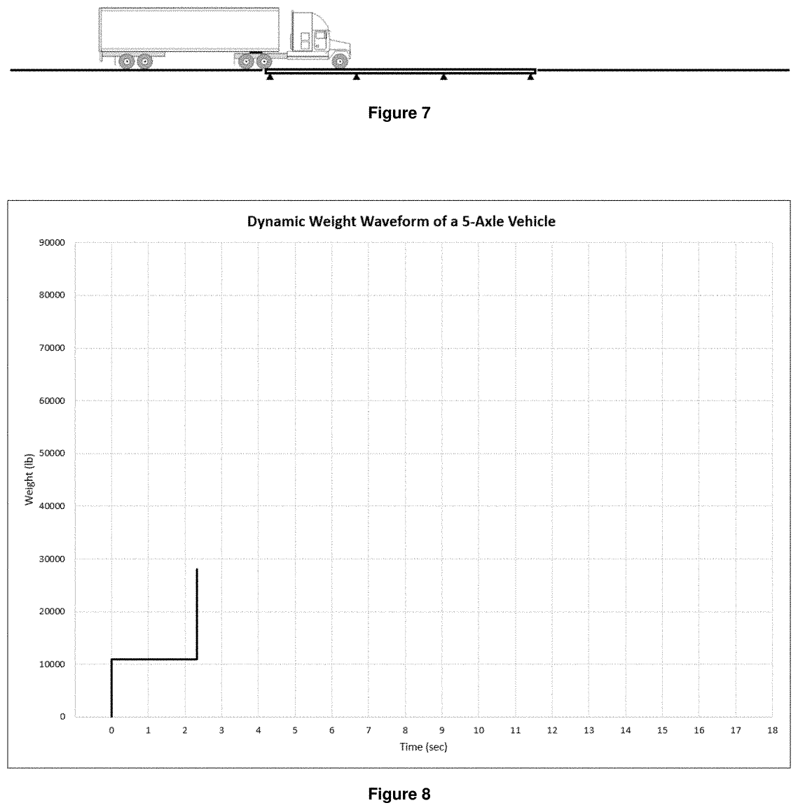

FIG. 7 illustrates the weight scale of FIG. 3 with two sets of the truck axles on the weight scale. FIG. 8 illustrates the graph of FIG. 4 with two sets of axles on the weight scale. The weight reading of the weight scale remains constant as the truck moves across the weight scale from the time the first axle is on the scale to the time the second axle is about to move onto the weight scale (shown by a flat line of 10,890 pounds on FIG. 8). As the second set of axles of the truck moves onto the scale, the weight reading goes up again (to 28,080 pounds).

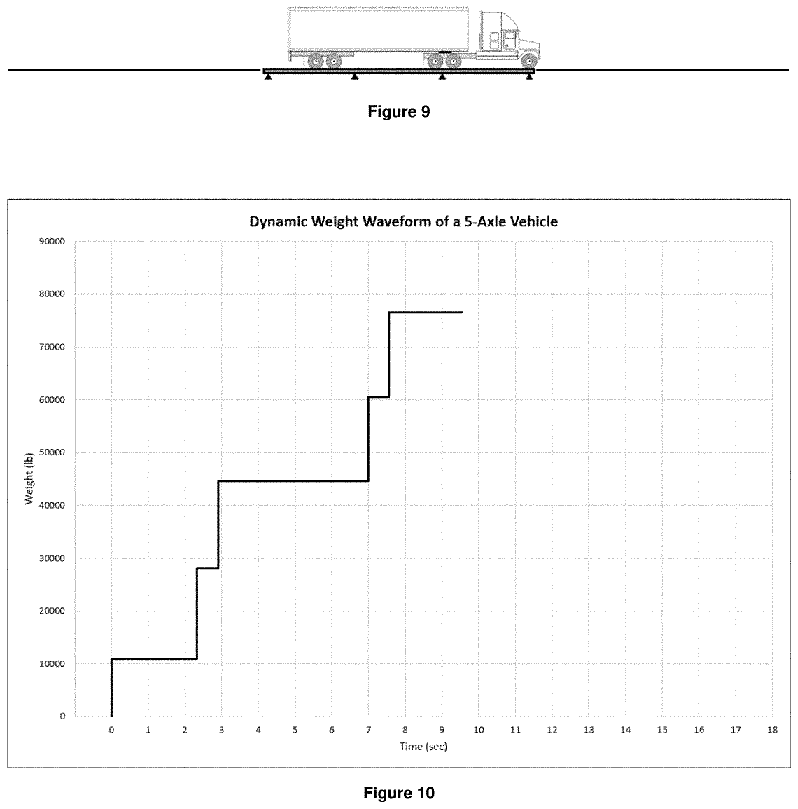

The weight readings on the graph will continue to rise in a step-wise fashion as the third, fourth, and fifth set of axles move onto the weight scale. FIG. 9 illustrates the weight scale of FIG. 3 with all five sets of the truck axles on the weight scale. FIG. 10 illustrates the graph of FIG. 4 with all five sets of axles on the weight scale. The weight reading of the weight scale remains constant at the maximum weight as the truck moves across the weight scale from the time the fifth axle is on the scale to the time the first axle is about to move off the weight scale (shown by a flat line of 76,650 pounds on FIG. 10).

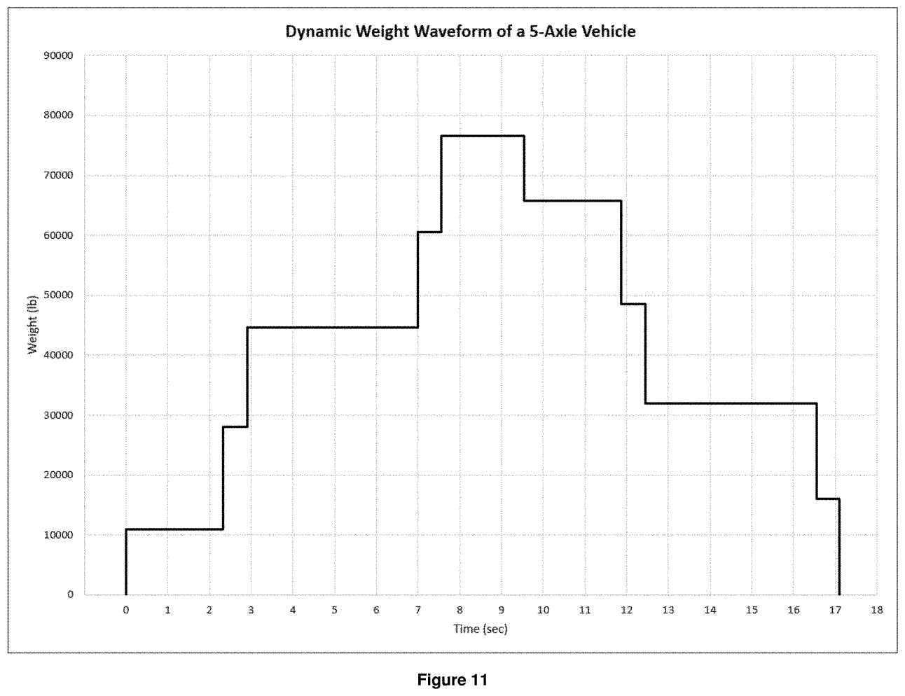

As the first set of truck axles moves off the scale, the weight reading will decrease. Again, as the remaining sets of axles move across the weight scale and then off the weight scale, the weight readings will decrease in a step-wise fashion until the final set of axles are off the weight scale when the weight reading will again go back to zero. FIG. 11 illustrates the weight readings of the truck of FIG. 3 as a function of time for the dynamic weighing process from the time the truck approaches the weight scale to the time the truck is moving across the weight scale, and finally to the time the truck is completely off the weight scale.

As illustrated in FIGS. 3-11, the shape of the dynamic weight waveform of the vehicle can be used to determine when all the vehicle's axles are on the scale. As the vehicle drives onto the scale, the weight increases in a stepwise fashion as each of the vehicle's axles comes onto the scale. When all the vehicle's axles are on the scale, the weight reaches a maximum. As the vehicle drives off the scale, the weight decreases in a stepwise fashion as each of the vehicle's axles comes off the scale. The amount the weight decreases as each of the vehicle's axles comes off the scale is equivalent to the amount it increased as each of the vehicle's axles came on the scale.

All of the vehicle's axles are on the scale during the time when the waveform is at its maximum value provided that all of the steps before that time were increasing and all of the steps after that time were decreasing, and the magnitude of the increasing steps per axle are equivalent to the magnitude of the decreasing steps. As shown in the example, the entire waveform is captured in order to determine the specific time period when all the vehicle's axles were on the scale.

The above example is representative of a vehicle carrying a solid cargo. However, if the vehicle is a tanker carrying liquid, the waveform may be less distinct. In the case of a tanker vehicle, the liquid may move around within the tank and redistribute the load on the axles. The load may be redistributed to some axles that are on the scale and some axles that are off the scale. However, the general trend of increasing steps before all axles are on the scale and decreasing steps after all axles have been on the scale is still valid.

In the preferred embodiment, the hardware processing system is programmed with further instructions when executed configure the processor to:
indicate an error in the dynamic weight obtained if the weight signal waveform is not a proper waveform;
determine if the vehicle is moving on the weight scale during the weighing process by detecting the transfer of weight as the vehicle moves across the weight scale;
determine if the vehicle is moving on the weight scale during the weighing process by detecting the transfer of weight among the first, second, third and fourth load cells as the vehicle moves across the weight scale;
   automatically determine the weight of the moving vehicle dynamically if the vehicle is moving on the weight scale during the weighing process;
   display the total weight obtained dynamically;
   indicate the total weight as a dynamically obtained weight reading; and estimate the speed of the vehicle from the rate of weight transfer among the load cells.

The static or dynamic weighing mode is preferably indicated on the terminal display, and any printed, transmitted or stored records. There may be two separate terminals for the static and dynamic weighments, or one terminal but with two separate displays for the static and dynamic weighments, or preferably one terminal with one display but with an indication for a static and dynamic weighment.

In a preferred implementation, the sensors used to determine when the vehicle is entirely on the scale and if the vehicle has stopped or remains in motion are digital load cells supporting the weighing platform. The load cells are connected to the terminal in a digital network such that the terminal receives the weight signal from each individual load cell. In this way the load carried by each load cell can be determined. When the vehicle drives onto the scale, the weight increases in a stepwise fashion as each of the vehicle's axles comes onto the scale. When all the vehicle's axles are on the scale, the weight reaches a maximum (i.e., the total weight). When the vehicle drives off the scale, the weight decreases in a stepwise fashion (in a substantially inverse symmetrical fashion) as each of the vehicle's axles comes off the scale. An example of the total weight signal waveform is shown in FIG. 2. All of the truck's axles are on the single draft scale when the weight reaches its maximum as shown in FIG. 2 between times 145 and 165.

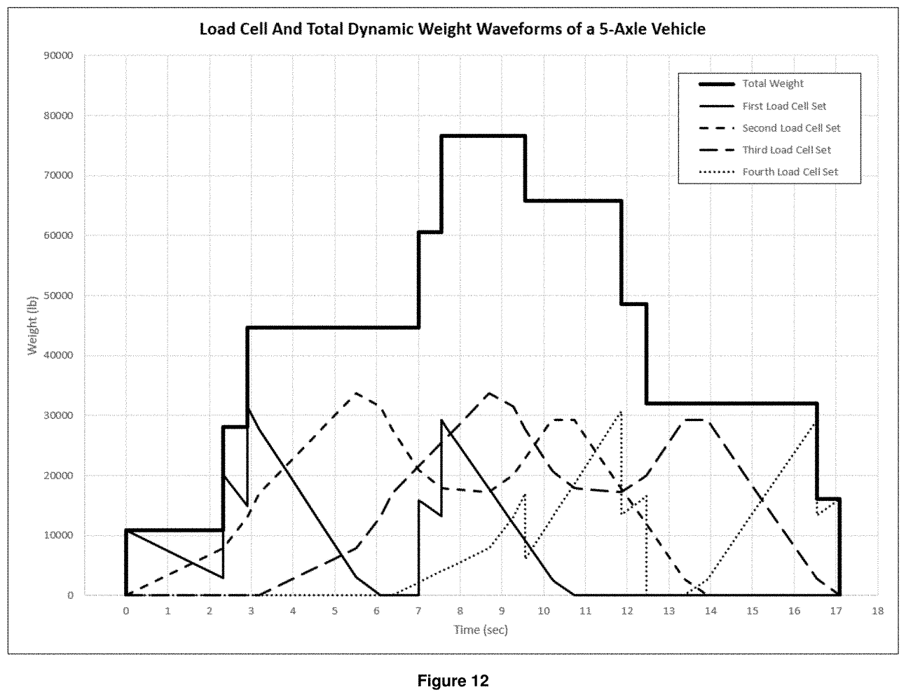

FIG. 12 illustrates the weight output of the first, second, third and fourth sets of load cells as the truck is moving across the weight scale. The total weight waveform is created by summing the individual load cell outputs. The transfer of weight among load cells along the longitudinal length of the scale from entry to exit is used to detect if the vehicle has come to a complete stop or remains in motion. The processor monitors the weight signal from each of the individual digital load cells. If weight is not being transferred from load cell to load cell along the longitudinal length of the scale, then the vehicle has come to a complete stop. If weight is being transferred from load cell to load cell along the longitudinal length of the scale, then the vehicle is in motion. The speed of the vehicle can be estimated from the rate of weight transfer among load cells since the position of the load cells are fixed. The speed of the vehicle can also be estimated from the time an axle first comes on the scale to the time the same axle comes off the scale since the length of the scale is fixed.

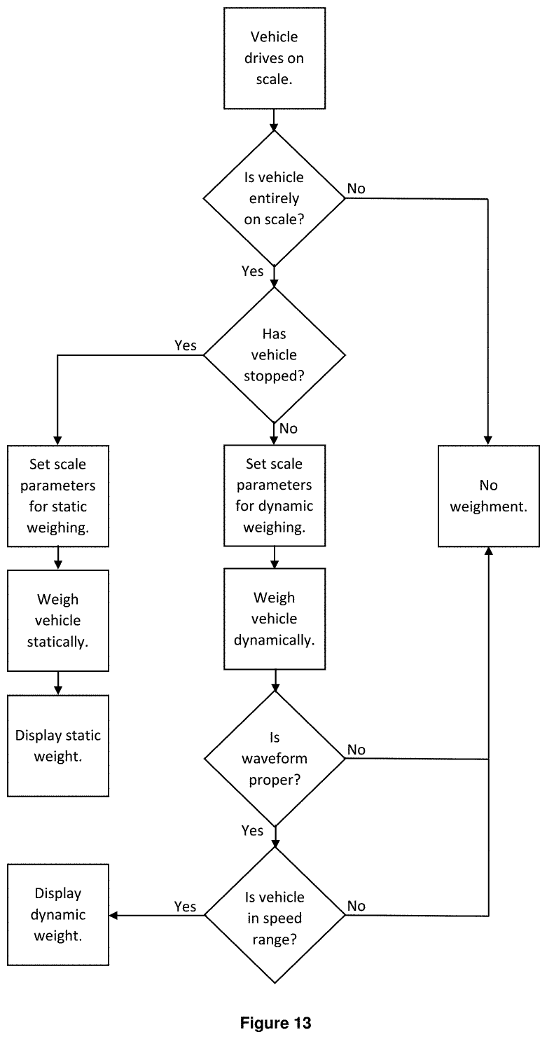

FIG. 13 illustrates the steps in the method of determining the total weight of a vehicle either statically or dynamically using the same weight scale as has been previously described.

While certain embodiments of the present invention are described in detail above, the scope of the invention is not to be considered limited by such disclosure, and modifications are possible without departing from the spirit of the invention as evidenced by the following claims.

What is claimed is:

1. A method for determining the vehicle weight either statically or dynamically using the same weight scale, comprising the steps of:
providing a weight scale for weighing vehicles that is of sufficient length that a plurality of axle sets of a vehicle can be located on the weight scale simultaneously;
sensing a vehicle weight as a function of time within the period of time the vehicle is on the weight scale;
obtaining the vehicle weight statically if all of the axle sets of the vehicle are located on the weight scale simultaneously and the vehicle is in a stopped condition;
obtaining the vehicle weight dynamically if all of the axle sets of the vehicle are located on the weight scale simultaneously and the vehicle is moving on the weight scale.

2. The method according to claim 1, further comprising the steps of:
determining that all the axle sets of the vehicle were located on the weight scale simultaneously and the vehicle is moving by analyzing a weight signal waveform as a function of time; and
determining the vehicle weight from a period of maximum weight readings of the weight signal waveform.

3. The method according to claim 2, wherein the weight signal waveform represents a proper waveform for dynamic weighing when the weight signal waveform increases in a stepwise fashion to a maximum level then decreases in a stepwise fashion in a substantially inverse symmetrical fashion.

4. The method according to claim 3, further comprising the step of:
indicating an error in the dynamic weight obtained if the weight signal waveform is not a proper waveform.

5. The method according to claim 1, further comprising the steps of providing multiple load cells consisting at minimum of:
a first load cell at a first end of the weight scale;
a second load cell at a second end of the weight scale.

6. The method according to claim 5, further comprising the steps of:
placing multiple load cells along the longitudinal axis of the weight scale at set distance intervals in the direction of vehicle movement; and
wherein the multiple load cells are digital load cells connected in a network and wherein they are configured to sense weight of loads.

7. The method according to claim 6, further comprising the step of:
determining if the vehicle is moving on the weight scale during the weighing process by detecting the transfer of weight among the multiple load cells as the vehicle moves across the longitudinal length of the weight scale.

8. The method according to claim 7, further comprising the step of:
estimating the speed of the vehicle from the rate of weight transfer among the load cells.

9. The method according to claim 1, further comprising the step of:
estimating a speed of the vehicle based on a time an axle of the vehicle first comes on the weight scale to a time the same axle comes off the weight scale, and a fixed length of the weight scale.

10. The method according to claim 8 or 9, further comprising the step of:
indicating an error if the speed of the vehicle during the weighing process was not within a speed operating range of the weight scale.

11. The method according to claim 1, further comprising the steps of:
automatically determining the weight of the moving vehicle dynamically if the vehicle is moving on the weight scale during the weighing process;
displaying the vehicle weight obtained dynamically; and
indicating the vehicle weight as a dynamically obtained weight reading.

12. The method according to claim 1, wherein the selection of static or dynamic weigh mode can be made manually by a scale operator, or automatically by the weight scale based on the detection of vehicle movement on the weight scale.

13. The method according to claim 1, further comprising the steps of:
providing a display for static weight measurement based on requirements for legal weights and measurements regulations; and
providing a display for dynamic weight measurement when the weighing process is completed.

14. The method according to claim 1, wherein different scale parameter settings may be applied when the weight scale is used in static or dynamic weigh mode including calibration factor, weight increment, number of weight intervals, or scale capacity either individually or in combination.

15. The method according to claim 14, wherein different scale parameters may be applied if at least one weigh mode of operation requires compliance with legal weights and measurements regulations.

16. An apparatus for determining the vehicle weight either statically or dynamically using the same weight scale and for displaying the vehicle weight on a terminal display, comprising:
a weight scale for weighing vehicles that is of sufficient length that a plurality of axle sets of a vehicle can be located on the weight scale simultaneously;
a plurality of weight sensors placed along the longitudinal length of the weight scale for sensing a vehicle weight as a function of time within the period of time the vehicle is on the weight scale;
a hardware processing system, in electronic communication with the terminal display and plurality of weight sensors, the hardware processing system programmed with instructions when executed configure the processor to:
obtain the vehicle weight statically if all of the axle sets of the vehicle are located on the weight scale simultaneously and the vehicle is in a stopped condition;
obtain the vehicle weight dynamically if all of the axle sets of the vehicle are located on the weight scale simultaneously and the vehicle is moving on the weight scale.

17. The apparatus according to claim 16, wherein the hardware processing system is programmed with further instructions when executed configure the processor to:
determine that all the axle sets of the vehicle were located on the weight scale simultaneously and the vehicle is moving by analyzing a weight signal waveform as a function of time; and
determine the vehicle weight from a period of maximum weight readings of the weight signal waveform.

18. The apparatus according to claim 17, wherein the weight signal waveform represents a proper waveform for dynamic weighing when the weight signal waveform increases in a stepwise fashion to a maximum level then decreases in a stepwise fashion in a substantially inverse symmetrical fashion.

19. The apparatus according to claim 18, wherein the hardware processing system is programmed with further instructions when executed configure the processor to indicate an error in the dynamic weight obtained if the weight signal waveform is not a proper waveform.

20. The apparatus according to claim 16, wherein the plurality of weight sensors are comprised of multiple load cells consisting at minimum of:
a first load cell at a first end of the weight scale;
a second load cell at a second end of the weight scale.

21. The apparatus according to claim 20, wherein the multiple load cells are set along the longitudinal axis of the weight scale at set distance intervals in the direction of vehicle movement; and
wherein the multiple load cells are digital load cells connected in a network and wherein they are configured to sense weight of loads.

22. The apparatus according to claim 21, wherein the hardware processing system is programmed with further instructions when executed configure the processor to determine if the vehicle is moving on the weight scale during the weighing process by detecting the transfer of weight among the multiple load cells as the vehicle moves across the longitudinal length of the weight scale.

23. The apparatus according to claim 22, wherein the hardware processing system is programmed with further instructions when executed configure the processor to estimate the speed of the vehicle from the rate of weight transfer among the load cells.

24. The apparatus according to claim 16, wherein the hardware processing system is programmed with further instructions when executed configure the processor to estimate a speed of the vehicle based on a time an axle of the vehicle first comes on the weight scale to a time the same axle comes off the weight scale, and a fixed length of the weight scale.

25. The apparatus according to claim 23 or 24, wherein the hardware processing system is programmed with further instructions when executed configure the processor to indicate an error in the dynamic weight obtained if the speed of the vehicle during the weighing process was not within a speed operating range of the weight scale.

26. The apparatus according to claim 16, wherein the hardware processing system is programmed with further instructions when executed configure the processor to:
automatically determine the weight of the moving vehicle dynamically if the vehicle is moving on the weight scale during the weighing process;
display the vehicle weight obtained dynamically; and
indicate the vehicle weight as a dynamically obtained weight reading.

27. The apparatus according to claim 16, wherein the hardware processing system is programmed with further instructions when executed configure the processor to allow the selection of static or dynamic weigh mode manually by a scale operator, or automatically by the weight scale based on the detection of vehicle movement on the weight scale.

28. The apparatus according to claim 16, wherein the hardware processing system is programmed with further instructions when executed configure the processor to:
provide a display for static weight measurement based on requirements for legal weights and measurements regulations; and
provide a display for dynamic weight measurement when the weighing process is completed.

29. The apparatus according to claim 16, wherein the hardware processing system is programmed with further instructions when executed configure the processor to allow different scale parameter settings to be applied when the scale is used in static or dynamic weigh mode including calibration factor, weight increment, number of weight intervals, or scale capacity either individually or in combination.

30. The apparatus according to claim 29, wherein the hardware processing system is programmed with further instructions when executed configure the processor to allow different scale parameters to be applied if at least one weigh mode of operation requires compliance with legal weights and measurements regulations.

31. A method for determining vehicle weight either statically or dynamically using the same weight scale, comprising the steps of:
providing a weight scale for weighing vehicles that is of sufficient length that a plurality of axle sets of a vehicle can be located on the weight scale simultaneously;
sensing a vehicle weight of the vehicle as a function of time within the period of time the vehicle is on the weight scale;
obtaining the vehicle weight statically if all of the axle sets of the vehicle are located on the weight scale simultaneously and the vehicle is in a stopped condition;
obtaining the vehicle weight dynamically if all of the axle sets of the vehicle are located on the weight scale simultaneously and the vehicle is moving on the weight scale;
determining that all the axle sets of the vehicle were located on the weight scale simultaneously and the vehicle is moving by analyzing a weight signal waveform as a function of time;
determining the vehicle weight from a period of maximum weight readings of the weight signal waveform; and
wherein different scale parameter settings may be applied when the scale is used in static or dynamic weigh mode including calibration factor, weight increment, number of weight intervals, or scale capacity either individually or in combination.
